(19) United States
(12) Patent Application Publication
(10) Pub. No.: US 2017/0185696 A1
(43) Pub. Date: Jun. 29, 2017

(54) AGGREGATING DATA FOR VISUALIZATION

(71) Applicant: HEWLETT PACKARD ENTERPRISE DEVELOPMENT LP, Houston, TX (US)

(72) Inventors: Rycharde HAWKES, Bristol (GB); Luis Miguel Vaquero GONZALEZ, Bristol (GB); Suksant Sae LOR, Bristol (GB); Romaric PASCAL, Bristol (GB); Liv FRANZEN, Bristol (GB)

(21) Appl. No.: 15/312,643

(22) PCT Filed: May 23, 2014
(86) PCT No.: PCT/US2014/039279

§ 371 Date: Nov. 19, 2016

(51) Int. Cl. G06F 17/30; G06F 3/0482

(52) U.S. Cl. CPC G06F 17/30991; G06F 3/0482

(57) ABSTRACT

Data items are aggregated based on information relating to a display capability of a display device, to produce aggregated data. The aggregated data is for display in a visualization presented by the display device. Responsive to user selection in the visualization, dynamically created data at a second hierarchical level different from a first hierarchical level of the aggregated data is for display in the visualization.

### BACKGROUND

Data can be collected from various sources and displayed for visualization by users. The visualization can be displayed in a display device of an electronic device. The visualization can include visual elements that represent respective data items.

### BRIEF DESCRIPTION OF THE DRAWINGS

Some implementations are described with respect to the following figures.

FIG. 1 is a block diagram of an example arrangement that includes a system according to some implementations.

FIG. 2 is a flow diagram of an example server visualization process, according to some implementations.

FIG. 3 is a flow diagram of an example visualization process, according to some implementations.

FIGS. 4 and 5 are schematic diagrams of example visualizations produced according to some implementations.

FIG. 6 is a schematic diagram of an example data model according to some implementations.

FIG. 7 is a flow diagram of an example process according to further implementations.

FIG. 8 is a block diagram of an example computer system, according to some implementations.

### DETAILED DESCRIPTION

Visualizing a large amount of data in a manner that can be understood by users can be challenging. For example, displaying a large amount of data can cause certain information to be occluded or hidden, which can make it difficult for users to recognize patterns or events in the visualized data.

Data for visualization can be collected from a source or a number of sources. Examples of data include measurement data regarding operations of electronic devices or machine-readable instructions. Examples of electronic devices include processors, computers (e.g. desktop computers, notebook computers, tablet computers, and server computers), storage systems, communication nodes, and so forth. Machine-readable instructions (e.g. software or firmware) can execute in electronic devices. During operation of an electronic device or during execution of machine-readable instructions, monitor agents can collect information relating to the operation of the electronic devices and/or machine-readable instructions, where the collected information can relate to one or multiple performance parameters of the electronic devices and/or machine-readable instructions.

In addition to performance data collected for electronic devices and/or machine-readable instructions, other types of data can be collected from other sources. Examples of other types of data can include financial data of an enterprise (e.g. business concern, educational organization, or government agency), environmental data (e.g. temperature, pressure, humidity, etc.), and so forth. In addition, data can be collected from social media sites, review sites, and so forth, such as data relating to sentiment or other feedback expressed by users.

Visualizing a large number of data items can be challenging, since visual elements representing the large number of data items can clutter the visualization or cause occlusion of certain data items. As a result, recognition of patterns, events, or other issues in the visualization can be difficult. A “data item” can refer to a data record or any other unit of data.

In addition, visualization of data items can be performed on different types of devices. In some cases, a visualization can be presented on a relatively large display device of a desktop computer. In other cases, a visualization can be presented on a display device of a smaller device, such as a notebook computer, a tablet computer, a smartphone, and so forth. Since the display space of different display devices can vary, the amount of data that can be effectively presented in each display device can be different. Generally, a larger display device can present a larger amount of information without cluttering or occlusion than a smaller display device.

A visualization can be interactive to allow a user to make selections in the visualization, such as to drill down to view further details in a particular portion of the visualization. Drilling down into a visualization can refer generally to focusing or zooming into a selected portion of the visualization, where the selected portion is less than an entirety of the visualization. The drilldown into the visualization causes display of data items in the selected portion, often with more detail than available with the overall visualization.

In accordance with some implementations, techniques or mechanisms are provided to allow for effective visualization of relatively large amounts of data. In some implementations, dynamic aggregation of data items in a collection of data items can be performed, where visualization is provided of the aggregated data, rather than the individual data items. The dynamic aggregation of data items can be based on various factors.

A first factor on which dynamic aggregation of data can be performed is the display capability of a display device used for presenting a visualization. A “display capability” of a display device can refer to a maximum or some other specified amount of information that can be displayed by the display device while still allowing a user to effectively recognize the data that is being displayed in the visualization. In some examples, the display capability can be expressed as a maximum number of data items that can be displayed by the display device. In other examples, the display capability can be expressed as one or multiple physical attributes of the display device, such as dimensions of the display device and a resolution (number of display pixels) of the display device. In other examples, other types of information indicating a display capability of a display device can be employed.

In some implementations, when a query is submitted to retrieve data from a collection of data items, information pertaining to the display capability of the display device is used for dynamically determining whether aggregation of data items retrieved in response to the query is to be performed. For example, a display capability of the display device can indicate that no more than a specified number of data items can be displayed. If the number of data items retrieved in response to the query exceeds the specified number, then aggregation of the retrieved data items is performed, and the aggregated data items are displayed in the visualization, rather than the retrieved individual data items, to reduce the number of data items visualized.

Another factor on which dynamic aggregation is based can include a user-selected operation. Examples of user-selected operations include any one or some combination of the following: a sort operation to sort data, a group operation to group data, a filter operation to filter data, a merge operation to merge data, or any other user-provided indicator that relates to which data items are to be aggregated. As examples, the user-selected indicator can allow a user to specify which data items are relevant or of interest to the user. Aggregation can be performed of such relevant or interesting data items. Dynamic aggregation based on a user-selected operation is discussed in additional detail further below.

In addition to being able to aggregate data items for visualization in response to one or multiple factors, techniques or mechanisms according to some implementations also allow for dynamic creation of data at a specific hierarchical level (from among multiple hierarchical levels) for visualization. The specific hierarchical level at which data is visualized is based on user request. For example, data returned for visualization in response to an initial query can be displayed at a first hierarchical level. In response to a drilldown request, data at a different hierarchical level can be visualized.

A visualization hierarchy can include multiple hierarchical levels at which data can be displayed. The different hierarchical levels correspond to display of different levels of detail. As an example, a first hierarchical level can correspond to data of an entire country. A second hierarchical level can correspond to data within a specific state of the country. A third hierarchical level can correspond to data within a specific county in a state.

Data to be visualized at different hierarchical levels can be created dynamically (i.e. on demand). As an example, data responsive to an initial query can be displayed in a visualization at a highest hierarchical level. A user can make a selection in the visualization to drill down into a specific portion of the visualization, which effectively is a request to visualize data at the next lower hierarchical level. A “lower” hierarchical level corresponds to a level that is focused on a smaller portion of the visualized data. Rather than pre-compute data for different hierarchical levels, data at certain lower hierarchical levels can be created dynamically in response to the user request (e.g. selection of a specific portion of the visualization).

Note that when data at a first hierarchical level is displayed in the visualization, the data at the second hierarchical level can be pre-computed in anticipation of user drilldown to the second hierarchical level. The pre-computed data at the second hierarchical level is ready for display upon user drilldown to the second hierarchical level. However, data at lower hierarchical levels may not be pre-computed, but rather are dynamically created in response to further user drilldown selections.

By dynamically computing data for different hierarchical levels (in response to user requests), scalability is improved, since data visualization according to some implementations can effectively visualize data for a collection of data items that can vary in size. If data for visualization at different hierarchical levels is pre-computed, then an increase in size of the collection of data items can result in re-computing the data for visualization at different hierarchical levels, which can be inefficient.

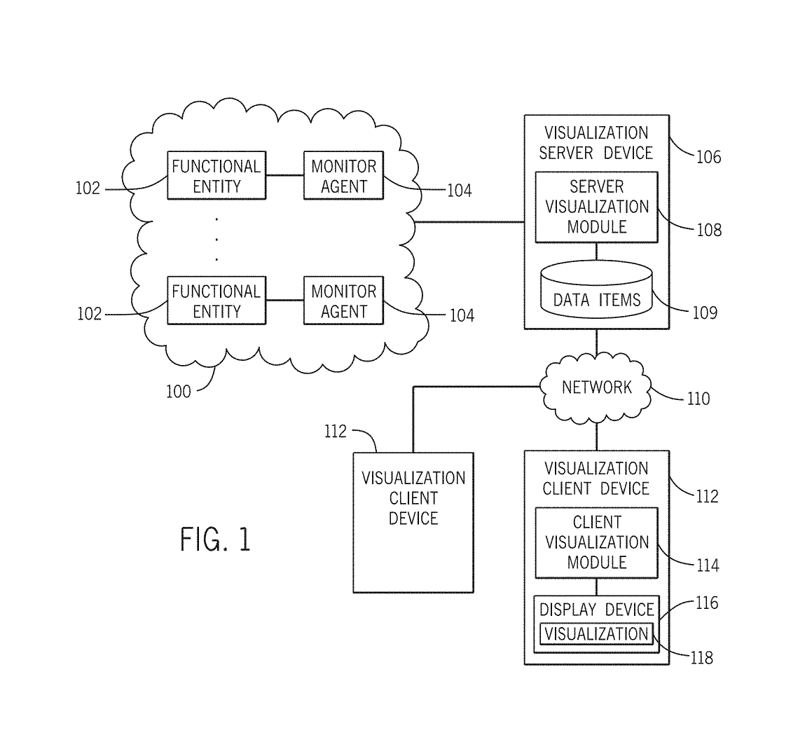

FIG. 1 is a block diagram of an example system that includes an arrangement 100 of functional entities 102. The function entities can include electronic devices, machine-readable instructions (e.g. software or firmware), or any other entity for which data can be collected, such as an enterprise, a department within the enterprise, websites, and so forth. Monitor agents 104 can be associated with the functional entities 102 for collecting data associated with the functional entities 102. Although FIG. 1 shows a one-to-one correspondence between functional entities 102 and monitor agents 104, it is noted that multiple functional entities 102 can be associated with one monitor agent 104, or alternatively, multiple monitor agents 104 can be associated with one functional entity 102.

The monitor agents 104 are able to communicate with a visualization server device 106, which includes a server visualization module 108. The visualization server device 106 can be implemented as a computer, or as multiple computers. The server visualization module 108 can be implemented as machine-readable instructions that can perform various tasks associated with visualizing data, as discussed further below. Although just one visualization server device 106 is depicted in FIG. 1, it is noted that in alternative examples, more than one visualization server device 106 can be employed.

The visualization server device 106 is coupled to a data network 110, such as the Internet, a local area network (LAN), a wide area network (WAN), a virtual private network (VPN), and so forth. Visualization client devices 112 are also coupled to the network 110. Examples of the visualization client devices 112 include computers (e.g. desktop computers, notebook computers, tablet computers, etc.), smartphones, and so forth.

Each visualization client device 112 includes a client visualization module 114, which can be implemented as machine-readable instructions that can perform various tasks with respect to visualizing data, as discussed further below.

Each visualization client device 112 can also include a display device 116, which can be used for displaying a visualization 118 of data collected by the monitor agents 104. The display device 116 can be part of the visualization client device 112, or alternatively, can be separate from but coupled to the visualization client device 112.

Although FIG. 1 illustrates visualization tasks performed by the visualization server device 106 and the visualization client device 112, it is noted that in other examples, visualization tasks can be performed by just one device, such as by a visualization client device 112.

In some examples, the client visualization module 114 executing in a visualization client device 112 can respond to a user request by sending a query over the network 110 to the visualization server device 106. The query can include one or multiple search terms or criteria. Data items that satisfy the one or multiple search terms or criteria are retrieved from a collection 109 of data items. The retrieved data items, which are responsive to the query, are visualization at the visualization client device 112.

In some implementations, as noted above, the query submitted by the client visualization module 114 can be associated with information indicating a display capability of the display device 116. In response to the information indicating the display capability of the display device 116, the server visualization module 108 can perform dynamic aggregation of retrieved data items that are responsive to the query. The server visualization module 108 then returns aggregated data to the client visualization module 114, which presents the aggregated data for display in the visualization 118 in the display device 116 of the visualization client device 112. For example, if the information indicating the display capability of the display device 116 specifies that the display device 116 is able to display up to a maximum of 50 data items, then the server visualization module 108 can aggregate retrieved data items from the collection 109 if the number of retrieved data items exceeds 50. For example, if the number of retrieved data items is 10,000, then the server visualization module 108 can aggregate the 10,000 data items into respective aggregated data items, such that the number of aggregated data items is 50 or less. The aggregated data items are then returned by the server visualization module 108 to the client visualization module 114 for display in the visualization 118.

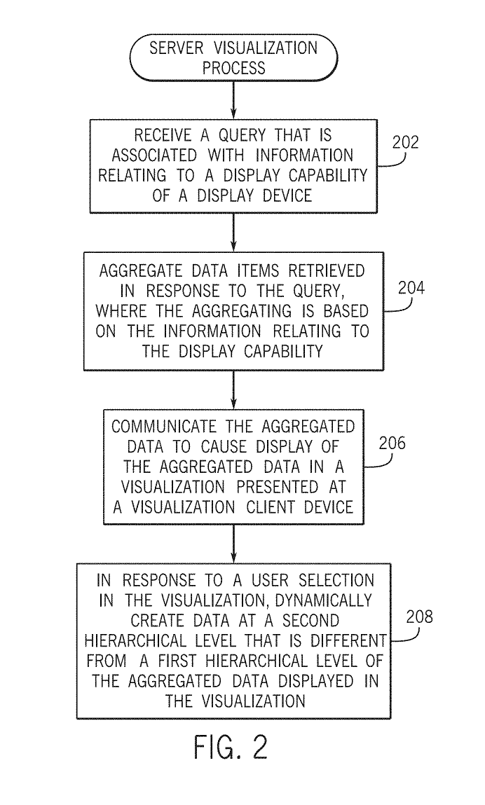

FIG. 2 is a flow diagram of a process performed by the server visualization module 108, according to some examples. The server visualization module 108 receives (at 202) a query (such as from the client visualization module 114) that is associated with information relating to a display capability of a display device (e.g. display device 116). The information relating to the display capability of the display device can be included in the query, or can be provided to the server visualization module 108 separately from the query.

The server visualization module 108 aggregates (at 204) data items retrieved from the collection 109 in response to the query, where the aggregating is based on the information relating to the display capability of the display device.

The aggregation that can be performed of data items can include computing an average of an attribute(s) of retrieved data items, a count of retrieved data items, a sum of an attribute(s) of retrieved data items, a median of an attribute(s) of retrieved data items, a maximum of an attribute(s) of retrieved data items, a distribution of an attribute(s) of retrieved data items, a mode of an attribute(s) of retrieved data items (where a mode refers to the most frequent value in a group of data items), and so forth.

After the aggregating, the server visualization module 108 communicates (at 206) the aggregated data to cause display of the aggregated data in a visualization presented by the display device (e.g. visualization 118 in display device 116 in FIG. 1).

Moreover, the server visualization module 108 is also able to respond to user selection in the visualization. One of the user selections can be to drill down into a selected portion of the visualization to see additional details regarding data items in the selected portion. In response to such a user selection in the visualization, the server visualization module 108 dynamically creates (at 208) data at a second hierarchical level that is different from a first hierarchical level of the aggregated data displayed in the visualization. The dynamically created data can be sent by the server visualization module 108 to the client visualization module 114 for display in the visualization.

Although FIG. 2 depicts aggregating of data items based on information relating to the display capability of the display device 116, in other examples, the aggregating of data items can further be based on a different aggregation factor, such as the user-selected operations or other user-provided indicator discussed further above.

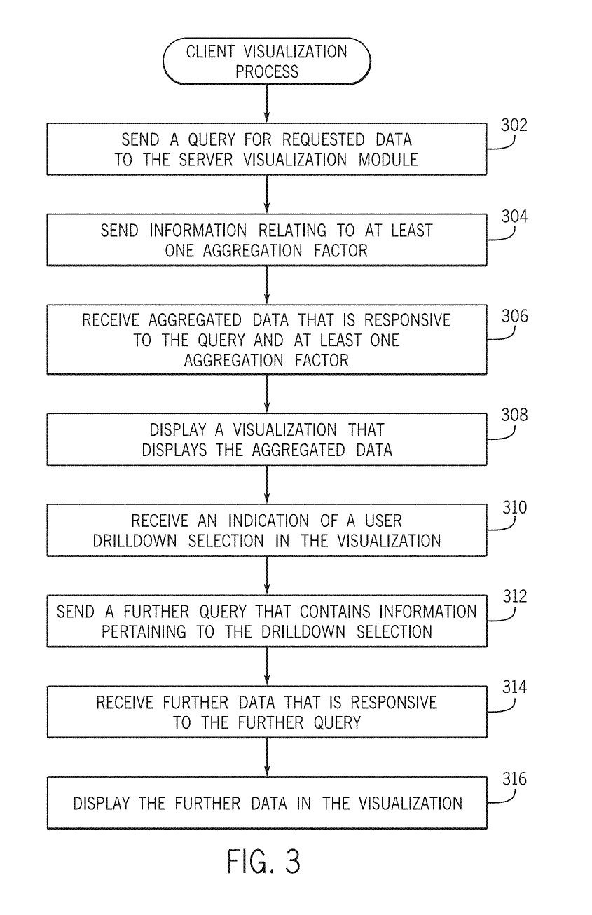

FIG. 3 is a flow diagram of an example process of the client visualization module 114 according to some implementations. The client visualization module 114 responds to a user request at the visualization client device 112 by sending (at 302) a query for requested data to the server visualization module 108. For example, the user may request the visualizing of data items relating to performance of server computers of an enterprise throughout the United States in a given month. In response to such a request, the client visualization module 114 can generate the query that contains search terms and criteria seeking performance data of server computers located in the United States in the given month.

The client visualization module 114 is also able to send (at 304) information relating to at least one aggregation factor. In some examples, the at least one aggregation factor can include a display capability of the display device 116 of the visualization client device 112. The information relating to the display capability can be preconfigured and stored at the visualization client device 112. Alternatively, the client visualization module 114 is able to determine the display capability of the display device 116 of the visualization client device 112. The information relating to the display capability that is sent (at 304) can be part of the query, or alternatively, can be separate from the query but is otherwise associated with the query.

In further examples, the at least one aggregation factor can include a user-provided indicator. For example, the user-selected indicator can allow a user to specify which data items are relevant or of interest to the user. The user-selected indicator informs the server visualization module 108 how to identify which data items are more relevant or of more interest. Aggregation can be performed of such identified data items.

The client visualization module 114 receives (at 306) aggregated data, which is responsive to the query and the at least one aggregation factor. The aggregated data is produced by aggregating data items retrieved in response to the query at the visualization server device 106. As noted above, the aggregation of data items can be based on the at least one aggregation factor.

The client visualization module 114 then displays (at 308) a visualization that displays the aggregated data.

The client visualization module 114 is also able to receive (at 310) an indication of user interaction with the visualization 118. For example, the user can use a user input device of the visualization client device 112 to interact with the visualization displayed in the display device 116. An example of user interaction is a user drilldown selection in the visualization, which selects a portion of the visualization.

In response to the user drilldown selection, the client visualization module 114 can send (at 312) a further query to the server visualization module 108, where the further query contains information pertaining to the drilldown selection. The client visualization module 114 receives (at 314) further data that is responsive to the further query from the server visualization module 108. The further data can be aggregated data or non-aggregated data, depending upon the number of data items included in the further data and the display capability of the display device 116.

The client visualization module 114 displays (at 316) the further data in the visualization.

In alternative implementations, instead of performing some tasks associated with visualizing data on a visualization server device and other tasks associated with visualizing data on a visualization client device, the tasks associated with visualization data can be performed on one device, such as on a visualization client device. For example, the retrieval of data items from a collection of data items and the aggregating (e.g. task 204 in FIG. 2) of retrieved data items based on information relating to a display capability of a display device and/or another aggregation factor can be performed by a visualization client device instead of a visualization server device.

The dynamic aggregation of data items can have various characteristics, in some examples. The dynamic aggregation of data items can adapt the aggregation to the size and type of a display device (based on the information relating to the display capability) without making any assumptions about the nature of the underlying data to be represented. The dynamic aggregation of data items can also be responsive to a user action, such as specification of a user-provided indicator. Moreover, the visualizing of dynamically aggregated data items is performed without use of any predefined templates or predefined views for the visualization; rather, the visualizing of dynamically aggregated data items is based on the display capability of the display device and user interactions with the visualized data.

As noted above, a user can interact with the visualized data to drill down to lower levels if the user is interested. In some implementations, drilling down to inspect further details does not mean that the global context is lost. When large amounts of data are displayed, zooming into a specific portion of the visualization can cause the overall global context (or global view) to be lost, such that a user may lose the big picture and become buried in the details. To avoid the foregoing issue, a view of the data at a higher hierarchical level can be maintained in the visualization even as the user drills down to view data at lower hierarchical levels. In this manner, the user can retain the global context (or global view) of the data.

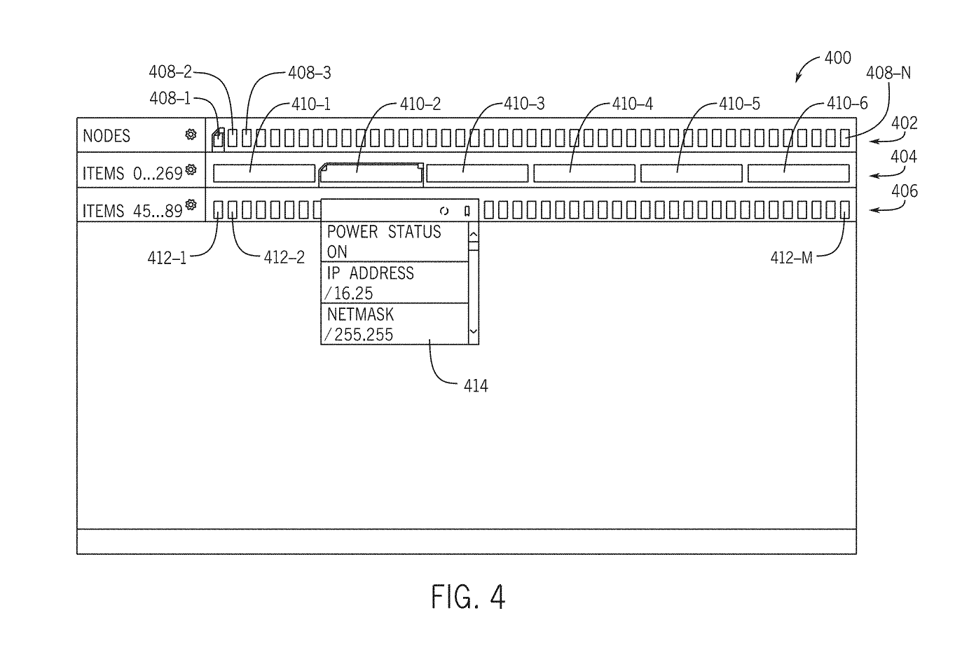

FIG. 4 illustrates an example visualization 400 that can be generated by the client visualization module 114, in accordance with some implementations. The visualization 400 includes multiple rows 402, 404, and 406 of visual elements. The different rows 402, 404, and 406 of visual elements can correspond to different hierarchical levels.

For example, the row 402 includes visual elements 408-1, 408-2, 408-3 . . . , 408-N that represent aggregated data items at a highest hierarchical level. The rows 404 and 406 contain visual elements that represent data items at lower hierarchical levels.

In examples where a user-provided indicator is provided to the server visualization module 108 to allow for an identification of data items that are more relevant or interesting, an aggregated data item that corresponds to the aggregation of such identified data items can be displayed in a more prominent portion of the visualization 400, such as in visual element 408-1.

Although reference is made to rows of visual elements in the example of FIG. 4, it is noted that visual elements can be arranged in other orientations in other examples, such as in columns or other arrangements. More generally, visual elements can be arranged along a line (e.g. a row or column).

Each visual element 408-i (i=1-N) of the row 402 represents an aggregated data item that is computed by aggregating a respective subset of data items in the collection 109 shown in FIG. 1. The number, N, of visual elements in the row 402 is based on the display capability of the display device in which the visualization 400 is displayed. For example, the display capability may indicate that a specified maximum number of data items can be presented in a row of the visualization 400. In this case, the server visualization module 108 aggregates respective subsets of data items to form a number, N, of aggregated data items that is less than the specified maximum number.

In the example of FIG. 4, to perform drilldown, a user has selected the visual element 408-1, which triggers a request to drill down to view details of data items corresponding to the aggregated data item represented by the visual element 408-1.

In response to the drilldown selection of the visual element 408-1, a further query is sent (e.g. task 312 in FIG. 3) by the client visualization module 114 to the server visualization module 108. In response to the further query, the server visualization module 108 dynamically creates further aggregated data items in response to the further query. The further aggregated data items are represented by visual elements 410-1, 410-2, . . . , and 410-6 in the next row 404.

Each further aggregated data item is computed by aggregating data items at a different level than the aggregation performed for the aggregated data items represented by the visual elements 408-1 to 408-N in the row 302. For example, each visual element 408-i can represent an aggregated data item that is an aggregation of a first number of data items of the collection 109. In contrast, each visual element 410-j (j=1-6) represents an aggregated data item that is an aggregation of a smaller number of data items in the collection 109, since each visual element 410-j represents data at a different drill down level.

In some examples, the further aggregated data items at the level represented by the visual elements 410-j may have been pre-computed, rather than dynamically created.

As further shown in the example of FIG. 4, a user can select visual element 410-2 to perform a further drilldown, which causes an additional query to be sent to the server visualization module 108.

The server visualization module 108 provides data items (which are dynamically created) in response to the additional query. In the example of FIG. 4, the data items provided by the server visualization module 108 in response to the additional query can be individual (non-aggregated) data items. The individual data items are represented by visual elements 412-1, 412-2, . . . , 412-M displayed in the last row 406. Also, in the example of FIG. 4, one of the visual elements 412-1, 412-2, . . . , 412-M has been selected to cause a pop up dialog box 414 to be displayed to show further details associated with attributes of the data item represented by the selected visual element 412-k (k=1-M).

In the visualization 400, visual elements representing respective data items do not overlap each other, so no data occlusion occurs.

In accordance with some implementations, a visualization system is also able to propagate an event across views of data at different hierarchical levels. For example, an event that has been detected for an individual data item represented at a lower hierarchical level in a visualization can be propagated to a view of data at a higher hierarchical level in the visualization. An event can correspond to any issue that may be of interest to a user, such as a parameter having a value that exceeds a threshold, a detected failure, and so forth.

FIG. 5 illustrates an example visualization 400′ that can be displayed by the client visualization module 114, in accordance with some implementations. The visualization 400′ is the same as the visualization 400 of FIG. 4, except that visual indicators representing a given event have been added to the visualization 400′.

The given event is associated with an individual data item represented by a visual element 412-13 in row 406′ of the visualization 400′. For example, the given event may correspond to an attribute of the individual data item represented by the visual element 412-13 exceeding a threshold. The given event is represented by an event visual indicator 502 that overlays or is otherwise associated with the visual element 412-13. In accordance with some implementations, the given event is propagated to the other views in rows 404′ and 402′. More specifically, an event visual indicator 504 representing the given event is associated with the visual element 410-2 in row 404′, and an event visual indicator 506 representing the given event is associated with the visual element 408-1 in row 404′

By propagating event visual indicators representing the given event across multiple views (in rows 402′, 404′, and 406′), a user can more easily see which data item (or group of data items) the given event is associated with.

Note that a propagated event can represent an aggregation of events. For example, multiple machines may have shut down due to overloading. Instead of reporting individual events for the respective multiple machines, an aggregated event can be reported, where the aggregated event can represent the average load at the multiple machines, for example.

To be able to propagate an event across different views (for different hierarchical levels) of a visualization, the client visualization module 114 can employ parent-child relationships across data items represented in the visualization.

The server visualization module 108 can keep track of relationships of views at different hierarchical levels presented in each visualization client device 112. The relationships can be represented as a relationship tree (or other data structure), where multiple relationship trees can be maintained for views presented in multiple corresponding visualization client devices 112. When a user at a particular visualization client device 112 drills down from a higher-level view (e.g. 402 in FIG. 4) to a lower-level view (e.g. 404 in FIG. 4), the data items for the lower-level view are provided by the server visualization module 108 to the client visualization module 114. The server visualization module 108 also records the parent-child relationship between the data items of the higher-level view and the data items of the lower-level view, to create the respective relationship tree.

When the server visualization module 108 detects a given event that is associated with a particular individual data item, the particular individual data item can be flagged. Also, the server visualization module 108 can flag other data items related to the particular data item in the respective relationship tree. Flagging a data item can refer to associating an indicator with the data item to indicate that an event is associated with the data item.

The given event and the flagged relationship tree can be provided to the client visualization module 114. A client visualization module 114 can traverse the flagged relationship tree to flag visual elements in the different views to represent the given event, where the flagging of the visual elements is accomplished by depicting event visual indicators (e.g. 502, 504, 506 in FIG. 5) representing the given event.

Not all events are equally interesting or informative, so a user or a client visualization module 114 is able to specify a condition for propagation. If the condition for propagation is satisfied, then a detected event is visually depicted and propagated across different views. For example, an event can correspond to a car going over a speed limit on a small road in Iowa. Normally, such an event is not interesting and thus not visually depicted in a visualization. However, if the police is looking for a suspect in Iowa, then it may be interesting to visually depict such an event.

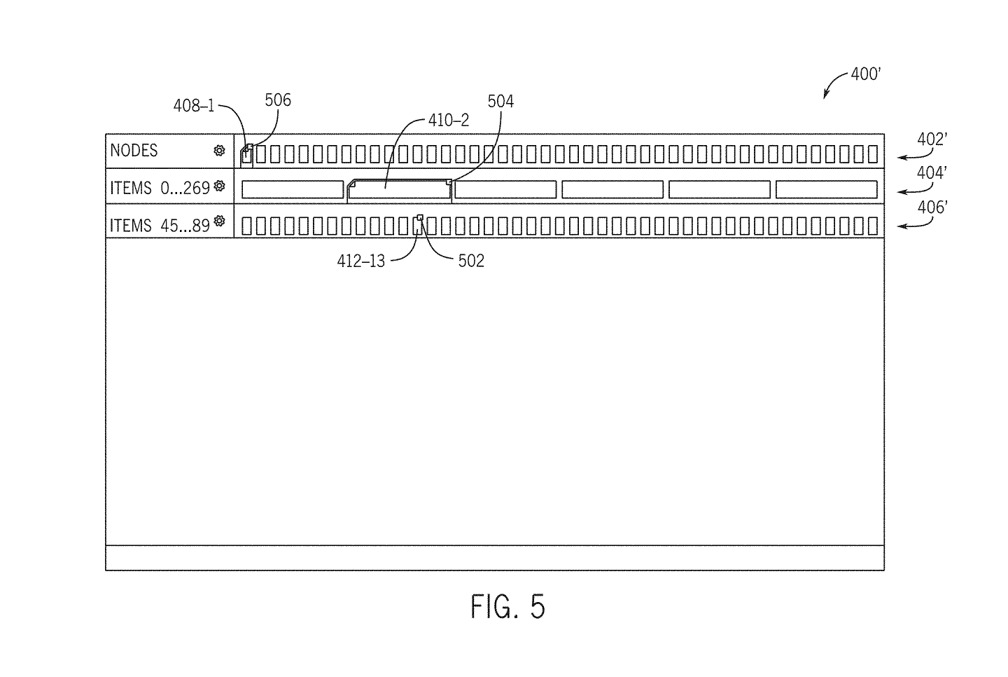

FIG. 6 illustrates an example data model 600 that corresponds to elements that can be displayed in a visualization according to some implementations. The data model includes a node 602 that represents a GraphicCollection element according to an example. The GraphicCollection element contains an Element (represented by node 604), which represents a data item that can be visualized. A node 604 can represent one of the visual elements 408-i, 410-j, and 412-k depicted in FIG. 4 or 5, for example.

The Element represented by node 604 can be an Aggregation element represented by node 606 or a SingleElement as represented by node 608. The Aggregation element represents an aggregated data item, while the SingleElement represents an individual (non-aggregated) data item.

As discussed above, dynamic aggregation of data can also be in response to a user-selected operation. Examples of user-selected operations include any one or some combination of the following: a sort operation to sort data, a group operation to group data, a filter operation to filter data, a merge operation to merge data, or some other operation with respect to data. An example of a filter operation can include filtering data items by some attribute (e.g. data items that refer to user A). The filtered data items (selected data items that satisfy the filtering criterion) can then be dynamically aggregated for visualizing.

In addition to the foregoing user-selectable operations, another operation can include an operation specified by an arithmetic function, which is a function that can apply an arithmetic function (e.g. sum, multiplication, etc.) on two or more than two data items. Another example user-selectable operation is an operation specified by a regular expression, such as an expression specifying data items that satisfy a specific criterion. User-selectable operations can also be specified by user-defined functions, which are functions that can be generated by users of a visualization system according to some implementations.

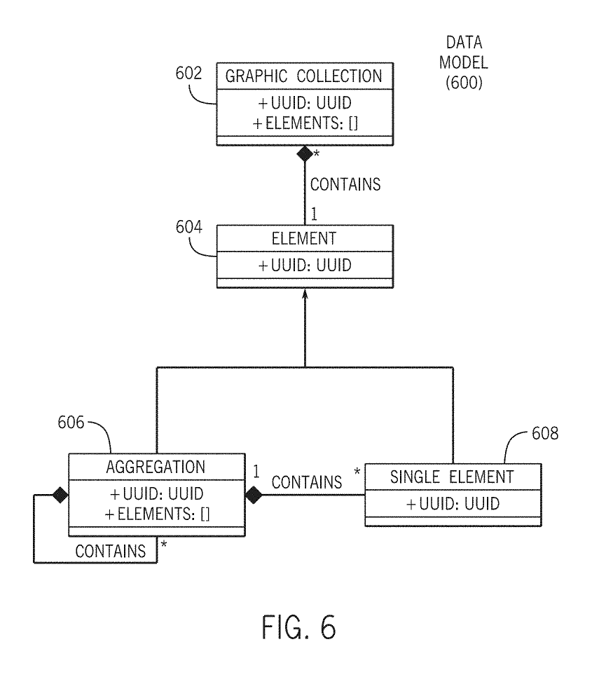

FIG. 7 is a flow diagram of a visualization process according to further implementations. The visualization client device 112 (or more specifically, the client visualization module 114) can receive (at 702) a set of one or multiple user-selected operations (such as those discussed further above) to apply. This set can be specified in a configuration file, or alternatively, can be based on user input in a graphical user interface (GUI) displayed by the display device 116 of the visualization client device 112.

The visualization client device 112 sends (at 704) a request that is associated with the set of one or multiple user-selected operations to the visualization server device 106. Note that the request sent (at 704) can be part of the query sent (at 302) by the visualization client device 112, or the request can be separate from such query.

In response to the request, the visualization server device 106 (or more specifically, the server visualization module 108) applies (at 706) the user-selected operation(s) in the set to data items. Note that if the visualization server device 106 does not support any of the user-selected operation(s) in the set, then the visualization server device 106 can issue an error notification to the visualization client device 112.

Assuming that the visualization server device 106 is able to apply the user-selected operation(s), the visualization server device 106 produces (at 708) result data based on application of the user-selected operation(s) in the set, and sends (at 710) the result data to the visualization client device 112 for display. Note that the result data can include aggregated or non-aggregated data items.

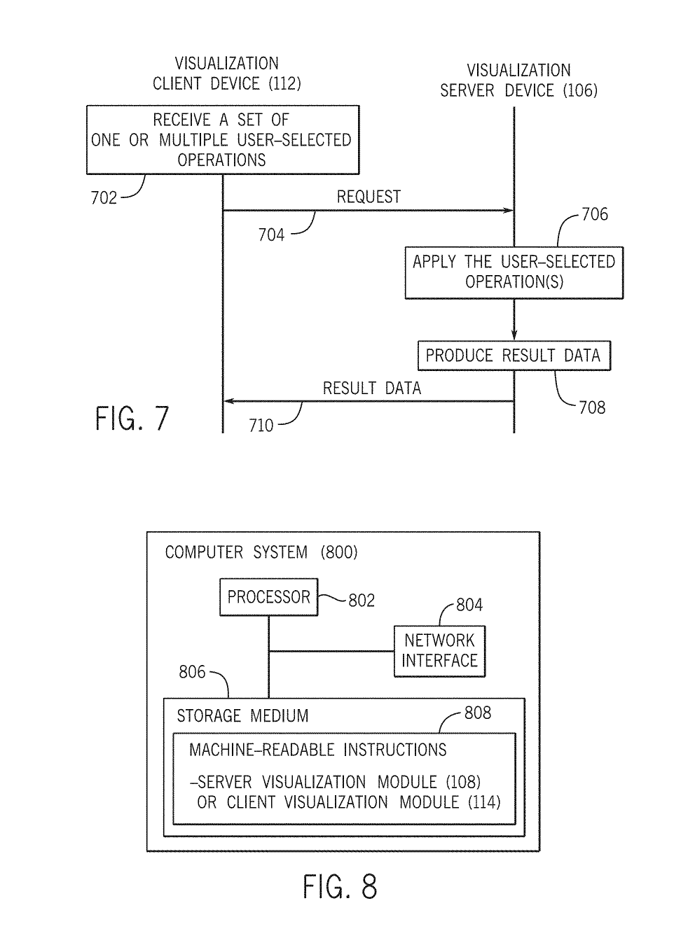

FIG. 8 is a block diagram of a computer system 800, which can be used to implement the visualization server device 106 or visualization client device 112 of FIG. 1. The computer system 800 can include one or multiple processors 802. A processor can include a microprocessor, microcontroller, processor module or subsystem, programmable integrated circuit, programmable gate array, or another control or computing device.

The processor(s) 802 can be coupled to a network interface 804 (for communicating over a data network) and a non-transitory machine-readable or computer-readable storage medium (or storage media) 806. The storage medium (or storage media) 806 can store machine-readable instructions 808, which can include the server visualization module 108 or client visualization module 114 of FIG. 1.

The storage medium (or storage media) 806 can be implemented with different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system including a processor, a query that is associated with information relating to a display capability of a display device;
aggregating, by the system, data items based on the information, to produce aggregated data;
communicating, by the system, the aggregated data to cause display of the aggregated data in a visualization presented by the display device; and
responsive to user selection in the visualization, dynamically creating data at a second hierarchical level different from a first hierarchical level of the aggregated data displayed in the visualization, the dynamically created data at the second hierarchical level for display in the visualization.

2. The method of claim 1, further comprising:
receiving, by the system, a user-provided indicator relating to aggregation of data;
identifying, by the system, a set of data items based on the user-provided indicator, to produce result data containing the data items that are subjected to the aggregating.

3. The method of claim 1, further comprising:
causing display of the dynamically created data at the second hierarchical level in the visualization while maintaining the display of the aggregated data at the first hierarchical level in the visualization.

4. The method of claim 3, wherein causing display of the aggregated data at the first hierarchical level comprises causing display of the aggregated data at the first hierarchical level in a first line of the visualization, and wherein causing display of the dynamically created data at the second hierarchical level comprises causing display of the dynamically created data at the second hierarchical level in a second line in the visualization.

5. The method of claim 1, further comprising:
providing information relating to an event to cause propagation of a visual indicator representing the event across a first portion of the visualization representing the aggregated data at the first hierarchical level and a second portion of the visualization representing the dynamically created data at the second hierarchical level.

6. The method of claim 5, further comprising flagging data items in a relationship tree that represents data items at different hierarchical levels, the flagged data items associated with the event, wherein the flagged relationship tree is usable to assign event visual indicators to respective visual elements in the visualization to represent the event.

7. The method of claim 1, wherein the information relating to the display capability comprises at least one selected from among a maximum number of data items displayable by the display device, and a physical attribute of the display device.

8. The method of claim 1, wherein the aggregated data items are pre-computed in response to display of data items at a prior hierarchical level.

9. The method of claim 1, wherein the system includes a server device, and the communicating comprises sending the aggregated data to a client device to display in the visualization presented by the client device.

10. A system comprising:
a display device; and
at least one processor to:
receive aggregated data items, the aggregated data items produced by aggregating data items retrieved in response to a query, the aggregating based on a display capability of the display device;
display the aggregated data items in a visualization presented by the display device;
receive a drilldown selection in the visualization to cause viewing at a second hierarchical level different from a first hierarchical level of the aggregated data items;
receive further data responsive to a request for the drilldown selection, the further data containing data items at the second hierarchical level, wherein the further data is dynamically created in response to the request for the drilldown selection; and
display the data items at the second hierarchical level in the visualization.

11. The system of claim 10, wherein the display of the aggregated data items at the first hierarchical level and the display of the data items at the second hierarchical level are dynamically provided without use of any predefined template or predefined view for the visualization.

12. The system of claim 10, wherein the visualization includes a first line containing visual elements representing the aggregated data items at the first hierarchical level, and a second line containing visual elements representing the data items at the second hierarchical level.

13. The system of claim 12, wherein the at least one processor is to further:
receive information for an event;
display event visual indicators representing the event, a first of the event visual indicators associated with a visual element in the first line, and a second of the event visual indicators associated with a visual element in the second line.

14. The system of claim 13, wherein the at least one processor is to further:
access a relationship data structure to identify data items at different hierarchical levels flagged as being associated with the event; and
use the relationship data structure to associate the event visual indicators with the respective visual elements in the first and second lines.

15. An article comprising at least one non-transitory machine-readable storage medium storing instructions that upon execution cause a server device to:
receive, from a client device, a query, information relating to a display capability of a display device of the client device, and a user-provided indicator relating to aggregation of data;
retrieve data items in response to the query;
aggregate the data items based on the information relating to the display capability and the user-provided indicator, the aggregated data items corresponding to a first hierarchical level for visualizing;
send the aggregated data items to the client device to cause display of the aggregated data items in a visualization at the client device;
receive a request in response to a drilldown selection made in the visualization;
dynamically produce data items in response to the request, the dynamically produced data items corresponding to a second, different hierarchical level for visualizing; and
send the dynamically produced data items to the client device to display in the visualization.
